(19) United States
(12) Patent Application Publication
(10) Pub. No.: US 2006/0193131 A1
(43) Pub. Date: Aug. 31, 2006

(54) Circuit devices which include light emitting diodes, assemblies which include such circuit devices, and methods for directly replacing fluorescent tubes

(76) Inventors: William Richard McGrath, Randolph, VT (US); Jason Paul Lewis, Rochester, VT (US); Jason Micheal Orzell, Randolph, VT (US); Oliver Alexander Piluski, Randolph, VT (US)

Correspondence Address: WILLIAM R. MCGRATH;C/O LEDOYNAWKS, P.O. BOX 444, RANDOLPH, VT, 05060-0444, US

(21) Appl. No.: 11/361,656

(22) Filed: Feb. 23, 2006

Related U.S. Application Data
(60) Provisional application No. 60/657,100, filed on Feb. 28, 2005.

(51) Int. Cl. B60Q 1/26

(52) U.S. Cl. 362/227

(57) ABSTRACT

An arrangement of a multiplicity of LEDs, drive circuitry, and supporting structure to form a replacement for standard fluorescent tubes without the need to rewire or remove the magnetic or electronic ballasts in use in standard fluorescent fixtures.

### CROSS REFERENCE TO RELATED APPLICATION

This application claims the benefit and priority of U.S Provisional Application Ser. No. 60/657,100 filed Feb. 24, 2005 entitled “Fluorescent Replacement Using Light Emitting Diodes.”

### FIELD OF THE INVENTION

The present invention relates to a circuit devices for providing energy to a series of light emitting diodes and an assembly including such circuit devices and light emitting diodes. The present invention relates to a light emitting diode (LED) assembly for direct replacement of a tubular fluorescent light bulb.

### BACKGROUND OF THE INVENTION

The widespead use of fluorescent tubes for general purpose lighting has several drawbacks. One significant drawback is their use of rare-earth and other toxic phosphors to generate light. This provides a problem when tubes which have ceased to function require disposal. The phosphors can present a toxic waste situation which must be dealt with. Also, because the envelope of the tube is thin glass, the potential for accidental breakage, with attendant problems of scattering toxic material, is high. For this reason, in food-related and other industries where potential contamination is a risk, special plastic protective sleeves are required to be placed on all fluorescent tubes. A drawback to the use of these sleeves is that they trap heat generated by the tube and increase the operating temperature of the tube which decreases the useful life of the device.

The ballasts used in fluorescent fixtures present an inductive load to the line resulting in a lower than unity power factor. While fluorescent lighting is longer lasting and more efficient than incandescent bulbs, the tubes have a short life relative to solid state lighting devices. Based on an eight hour per day use, LED lighting will have an average usable life ten times that of a fluorescent light source.

With the introduction of high current, high output LEDs, the use of these devices in general purpose lighting has become feasible. One area of general lighting which could benefit from this technology is fluorescent lighting. Heretofore, tubes meant to accomplish this were unable to work with standard magnetic or electronic ballasts, and required replacement or complete rewiring of the lighting fixture.

### SUMMARY OF INVENTION

The present invention provides a circuit arrangement which provides the proper drive to a multiplicity of LEDs, connected in a series string, by deriving the drive from standard magnetic or electronic ballast and commonly used fluorescent fixture wiring. A second circuit provides the capability of operation with any fixture wiring variation. A third circuit provides protection against the ballast generating a high “strike” voltage in the event that an LED fails open. Another embodiment is shown which provides dimming capability for the light. A fifth embodiment shows the interface circuitry for remotely dimming the LED light.

The present invention contains no glass or other easily breakable materials and no toxic substances are used. Therefore, there is no need for heat trapping protective sleeves or other covering devices to be used. The present invention also provides for means to remove the heat generated by the LEDs and thereby increase the useful life of the devices. The filter capacitance at the input of the present invention offsets, to some degree, the inductive load presented by the ballast and bring the input power factor closer to unity.

### DESCRIPTION OF THE DRAWINGS

Other features and advantages of the present invention will become apparent from the following description of embodiments of the invention which refers to the accompanying drawings, wherein:

FIG. 1 is a plan view of the final assembly of the embodiment of the invention.

FIG. 2 is a cross-sectional view of one end-cap of the assembly.

FIG. 3 is a cross-sectional view of the LED mounting and heat sink.

FIG. 4 is a schematic diagram of the basic embodiment of circuit elements and LEDs

FIG. 5 is a schematic diagram of an embodiment providing an arrangement of circuit elements to accommodate differing versions of fixture wiring.

FIG. 6 is a schematic diagram of a circuit which protects the circuit elements against damage from ballast-generated, high voltage “strike” voltages.

FIG. 7 is a schematic diagram of an embodiment providing dimming capability.

FIG. 8 is a schematic diagram of an embodiment providing interface circuitry for remote dimming of the device.

### REFERENCE NUMERALS IN DRAWINGS

10 Contact Pin
20 End Cap
30 Heat Sink
40 Bridge Rectifier
45 Bus Wire
50 Input Capacitor
55 Input Circuit Board
60 LED
70 LED Circuit Board
90 Thermally Conductive Isolator
100 Shut Down Triac
110 Overvoltage Sense Zener Diode
120 Current Setting Resistor
125 Control Circuit Board
130 NPN Power Transistor
140 Base Drive Resistor
150 Diode
200 N Channel MOSFET
210 P Channel MOSFET
220 Microprocessor
240 Voltage Regulator
250 Input Zener Diode
260 Filter Capacitor
270 Capacitor
280 Base Drive Resistor
290 NPN Transistor
300 Diode
310 Resistor
320 NPN Transistor
330 Resistor
340 Diode
350 Resistor
360 PNP Transistor
370 Zener Diode
380 Interface Device

### DETAILED DESCRIPTION OF EMBODIMENTS OF THE INVENTION

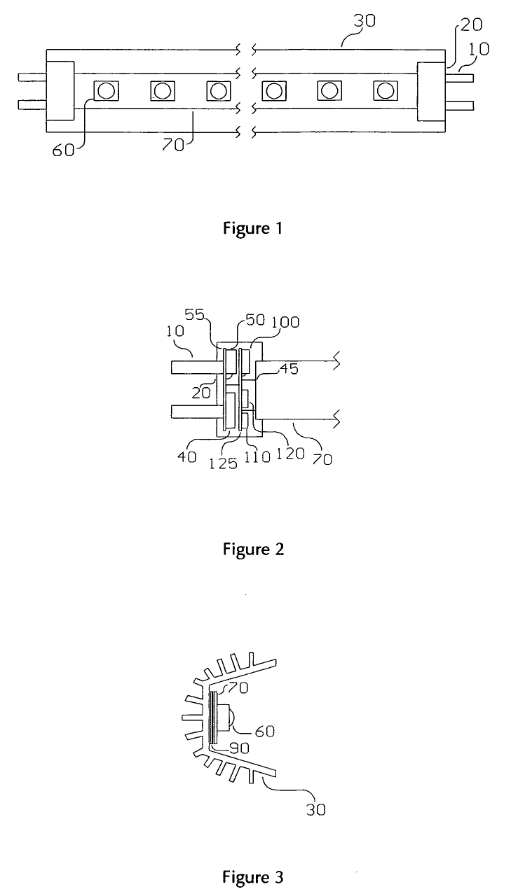

Referring now to the drawings, FIG. 1 shows a plan view of the preferred embodiment of the present invention. A multiplicity of LEDs 60 are mounted to the LED circuit board 70 and attached to two end caps 20. This assembly is mounted to heat sink 30 which also acts as a protective housing. The end caps 20 are fitted with contact pins 10, spaced such that they mate with standard fluorescent fixture connectors. The overall length of the assembly is equivalent to that of a standard fluorescent tube.

FIG. 2 is a cross-sectional of an end cap 20. Contact pins 10 are physically and electrically connected to the input circuit board 55 upon which are mounted the rectifier bridge 40 and capacitor 50. The input circuit board 55 is physically and electrically connected to the control circuit board 125 by bus wires 45. The shut down triac 100, overvoltage sense Zener diode 110, and current setting resistor 120 are mounted on control circuit board 125. These components are from the embodiment shown in FIG. 6 and are used for illustrative purposes only. As would be known to anyone skilled in the art, the components for any of the embodiments shown could be mounted to this board.

FIG. 3 is a cross sectional view of the LED mounting and heat sink. The LEDs 60 are mounted to LED circuit board 70. This assembly is affixed to the heat sink 30 with thermally conductive isolator 90 such as T-Flex 210, manufactured by Thermagon, or other such materials well known to anyone skilled in the art. Heat sink 30 consists of an aluminum extrusion coated with a material such as Powder Coat 10225 manufactured by The Eastman Company or other similar materials well known to anyone skilled in the art. This material, while being highly reflective to visible light has a high emissivity for infra-red. Conversely, the coating used on standard fluorescent fixtures, while being highly reflective to visible light, is an excellent absorber of infra-red. This combination permits heat sink 30 to effectively couple heat generated by the LEDs to the large area of the fluorescent fixture.

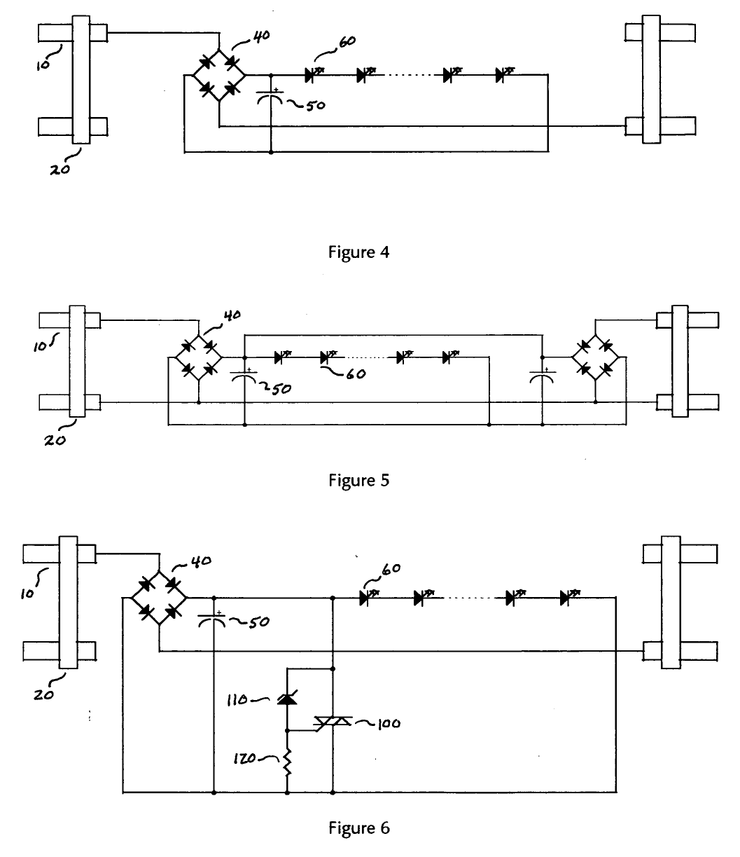

The operation of the LED drive circuits within the present invention will now be described in detail while referencing FIGS. 4 through 8. All of the drive circuits presented herein make use of the constant current characteristic of standard and magnetic ballasts. By choosing LEDs which require a current of this magnitude, the need for additional constant current drive circuitry is eliminated. FIG. 4 shows one type of drive for the LED string. A multiplicity of LEDs 60 is connected as a series string. The primary AC power is brought to the circuit by contact pins 10. The input voltage is rectified by bridge rectifier 40 and filtered by capacitor 50. The rectified, filtered voltage is then connected to the series string of LEDs 60. The embodiment shown in FIG. 4 will operate with the most common wiring configuration of fluorescent fixtures. FIG. 5 shows the preferred embodiment for input power conditioning. A second bridge rectifier and filter capacitor are added to those shown in FIG. 4. The embodiment of FIG. 5 allows the present invention to operate in any fluorescent fixture wired in accordance with prevailing electrical codes.

Should an LED in the series string fail as an open circuit, the ballast will sense that there is no current flowing and apply a high voltage “strike” voltage. This would normally cause the fluorescent tube to light. In the present invention, the “strike” voltage could cause serious damage to other components. To prevent this, the drive circuit shown in FIG. 6 is used. As shown, shut down triac 100 is connected across the power input to the LEDs 60. If a “strike” voltage occurs, overvoltage sense Zener diode 110 conducts current. At a current set by current setting resistor 120, a voltage sufficient to trigger shut down triac 100 into conduction will appear at its gate terminal. This shunts the voltage across the LED string and prevents possible catastrophic failure of other circuit elements.

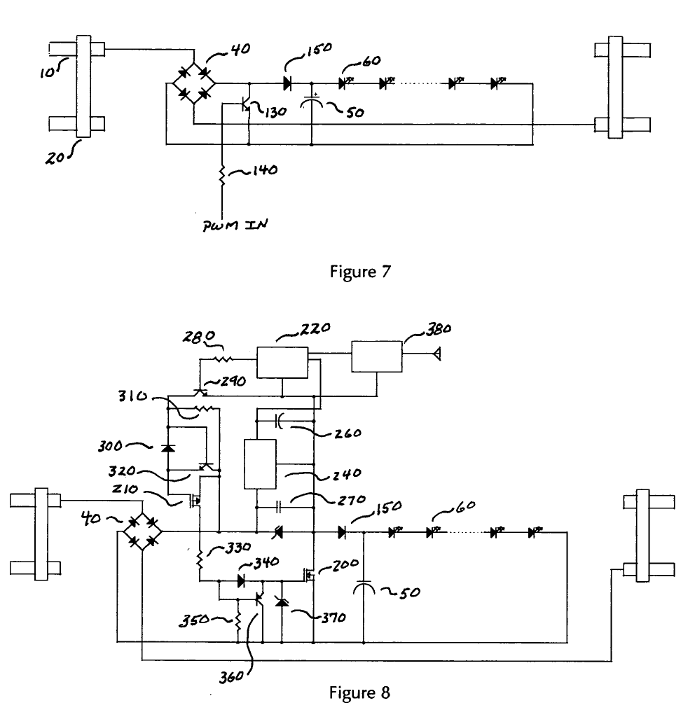

FIG. 7 is the same embodiment shown in FIG. 4 with a dimming capability provided by the addition of an NPN transistor 130, a base drive resistor 140, and diode 150. A pulse width modulated (PWM) signal is applied to the base of NPN transistor 130 through base drive resistor 140. This causes NPN transistor 130 to shunt the drive current to LEDs 60. By switching NPN transistor 130 on and off at a rate sufficiently high to prevent flicker, the apparent brightness of the LEDs 60 will vary as the on to off time ratio of NPN transistor 130 is varied. Diode 150 prevents NPN transistor 130 from discharging capacitor 50.

FIG. 8 shows an embodiment which provides a remotely controlled dimming capability. The interface device 380, which could be an infra-red, rf, or other type of receiver, sends command signals to microprocessor 220. Operating voltage for microprocessor 220 and interface device 380 is provided by a low voltage regulator consisting of input Zener diode 250, voltage regulator 240, filter capacitor 260, and capacitor 270. The output of microprocessor 220 provides a drive signal to a level shifting and gate drive circuit consisting of resistors 280, 310, 330, and 350, NPN transistors 290 and 320, PNP transistor 360, P channel MOSFET 210, diodes 300 and 340, and Zener diode 370. The gate drive signal is applied to N channel MOSFET 200. By switching N channel MOSFET 200 on and off, in the same manner as recited above for NPN transistor 130, the apparent brightness of LEDs 60 can be varied.

It will be apparent to anyone skilled in the art that the embodiment of FIG. 8 could be modified to control two strings of LEDs. By selecting warm white (low color temperature) for one string and cool white (high color temperature) for the other, that by varying the intensity of the strings with relation to each other, the resultant, effective color temperature could be controlled.

Although the description above contains specific heat sink, mounting, and assembly designs, these should not be construed as limiting the scope of the invention but as merely providing an illustration of the currently preferred embodiment.

Further, although various circuit configurations have been shown and described above there are numerous variations which can be used with the present invention, the specific design of which will be evident to one skilled in the art given the detailed description herein.

Thus, although the present invention has been described in relation to particular embodiments therof, many other variations and modifications will become apparent to those skilled in the art. It is preferred, therefore, that the present invention be limited not by the specific disclosure herein, but only by the appended claims.

What is claimed is:

1. A device to replace a fluorescent tube comprising:
a multiplicity of high power LEDs;
a drive circuit to provide operating current to the LEDs
a supporting structure providing heat dissipation for the LEDs

2. The LED arrangement according to claim 1 matched to the current characteristics of standard magnetic and electronic ballasts.

3. The LED arrangement according to claim 1 being driven by a circuit comprising a bridge rectifer and filter capacitor

4. The LED arrangement according to claim 1 being driven by a circuit comprising two bridge rectifiers and filter capacitors.

5. The LED arrangement according to claim 1 being driven by a circuit containing an over-voltage protection device.

6. The LED arrangement according to claim 1 being driven by a circuit accepting a pulse-width modulated signal to dim the light output.

7. The LED arrangement according to claim 1 being driven by a circuit accepting a remote control signal to dim the light output

8. The LED arrangement according to claim 1 being driven by a circuit providing color temperature control.

9. The supporting structure according to claim 1 treated with a high infra-red emissivity coating.
